(19) United States
(12) Patent Application Publication
(10) Pub. No.: US 2004/0166408 A1
(43) Pub. Date: Aug. 26, 2004

(54) Structurally integrated wire and associated fabrication method

(75) Inventors: David M. Anderson, Issaquah, WA (US); Michael A. Gamble, Puyallup, WA (US); Kenneth D. Pinyan, Seattle, WA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: The Boeing Company

(21) Appl. No.: 10/369,906

(22) Filed: Feb. 20, 2003

(51) Int. Cl. H01M 4/58

(52) U.S. Cl. 429/218.1

(57) ABSTRACT

A wire integrated with a structural member, a structural member having an integrated wire, and a method of manufacturing an integrated wire are provided. The wire is formed of a plurality of nonlinear tows that are disposed on the structural member in a generally longitudinal direction. The tows can be interlaced, for example, in a braided or woven configuration. Each tow is formed of fibers that can be coated with an electrically conductive metal, and strands of electrically conductive metal can also be interlaced with the fibers or tows so that the wire provides electrical communication for transmitting electrical signals or power. A structural material is disposed between the tows and joins the tows to the structural member.

### FEDERALLY SPONSORED RESEARCH OR DEVELOPMENT

This invention was made with government support under contract number NCC2-9019 awarded by the Rotorcraft Industry Technology Association, Inc. (RITA). The government may have certain rights in this invention.

### BACKGROUND OF THE INVENTION

1) Field of the Invention

The present invention relates to electrical wires and, in particular, to a wire that is integrated with a structural member and provides a path of electrical conductivity, for example, for transmitting signals or power through the structural member.

2) Description of Related Art

Electrical devices are often used in conjunction with a structural member. For example, electrical devices such as sensors and actuators can be embedded within, mounted on, or otherwise structurally integrated with the structure of a vehicle such as an airplane, spacecraft, land vehicle, ship, and the like. Other examples of electrical devices mounted in conjunction with a structural member can include machinery, buildings, and the like. The sensors can be used to detect temperature, motion, stress, strain, damage, and the like at different locations throughout the structure. The actuators can be used to adjust various control portions of the structure such as an elevator, rudder, aileron, helicopter rotor, door, or valve. Data generated by the electrical devices is typically communicated via electrical wires from the devices to a computer or other circuit device for processing. Similarly, control signals and electrical power are typically transmitted via electrical wires from the computer, power supply, and/or other circuit device to the actuators and sensors. Thus, a network of wires is often required for controlling and monitoring the electrical devices. Each wire usually includes one or more conductive strands, for example, copper strands, which are covered with an insulative jacket. Parallel wires can be held in groups with bundle fasteners, such as cable tie straps or shrink tubing. Fasteners such as clips, ties, and the like are often used to connect the wires or bundles of wires to the structural member at successive locations along the length of the wires so that the position of the wires is maintained.

In some applications, however, it is difficult or impractical to connect the wires to the structural member. For example, the structural member may not define any interior cavities through which the wires can be passed, and the environmental conditions outside the structural member may be harsh, for example, excessively warm or cold or subject to mechanical stress, moisture, or corrosive agents. Further, in applications where the structural member undergoes significant or repeated mechanical stress, the resulting strains in the wires can break the wires regardless of whether the wires are connected to the structural member.

One illustrative example is a blade of a helicopter rotor, which is rotated quickly around a hub of the rotor. In some cases, it may be desirable to provide wires that extend along the length of the blade, for example, to monitor sensors or control actuators in or on the blade. The wires cannot be connected to the outside of the blade because of the external conditions, e.g., wind, moisture, and the like. Further, the blade undergoes significant stress due to centripetal force when rotated at high speeds. If the wires are not connected successively or continuously along the length of the blade, each wire will also be strained due to the centripetal force that results from the rotation. On the other hand, if the wires are connected to the blade, the wires will be strained at the same rate as the blade. In either case, the stress that results in the wires can break or fatigue the wires, rendering the electrical devices ineffective.

Thus, there exists a need for a wire that can be provided along a structural member for transmitting electrical signals or power. The wire should be capable of being integrated with structural members and functioning in harsh environmental conditions that include strain and temperature variations, moisture, and corrosive agents. The wire should be adaptable to structural members without internal passages for the wires. Further, the wires should resist failure, even when the structural member is subjected to significant or repeated stresses.

### BRIEF SUMMARY OF THE INVENTION

The present invention provides a wire integrated with a structural member, a structural member having an integrated wire, and a method of manufacturing an integrated wire. The wire is formed of a plurality of nonlinear tows that are disposed on the structural member in a generally longitudinal direction. Fibers of the tows can be coated with an electrically conductive metal and/or interlaced with conductive strands so that the wire provides electrical communication along the structural member for transmitting electrical signals or power. A structural material is disposed between the tows to join them to the structural member. Thus, the tows are mechanically constrained by the structural member in a nonlinear, or multi-dimensional, configuration so that the tows of the wire are strained less than the structural member when the structural member is stressed. The structural member can also protect the wire from environmental conditions.

According to one embodiment of the present invention, at least two of the tows include an electrically conductive metal, and the conductive tows are electrically connected in a transverse direction that is generally perpendicular to the longitudinal direction of the tows. Thus, alternate paths exist for electrical current in the wire. The conductive tows can include nonmetallic fibers that are coated with a conductive metal to form, for example, carbon, nylon, aramids, or fiberglass tows coated with silver, nickel, gold, copper, beryllium, aluminum, or alloys thereof. The tows can be interlaced, for example, by braiding or weaving. According to other embodiments, strands formed of an electrically conductive metal such as silver, nickel, gold, copper, beryllium, aluminum, or alloys thereof can be interlaced with the tows such that the strands are also disposed in a nonlinear configuration. For example, three conductive strands can be grouped with each tow as the tows are woven or braided to form the wire. The tows and strands provide multiple, redundant paths for electrical communication along the wire. The structural material can be a nonconductive resin that is cured between the tows, and the structural member can be formed of a composite material that also includes a nonconductive resin. An insulative sheet can be disposed in the structural member to at least partially surround the wire.

The present invention also provides a structural member formed of a composite structure with at least one integrated wire disposed thereon. The wire extends between first and second electrical devices and electrically connects the devices. For example, the structural member can be a blade of a helicopter rotor, and the wire can extend in a direction between the ends of the blade. The devices can be sensors, actuators, or light-emitting devices that communicate via the wire.

The present invention also provides a method of manufacturing a wire integrated with a structural member. The method includes disposing a plurality of conductive tows so that the tows extend nonlinearly in a generally longitudinal direction and at least two of the tows are electrically connected in a transverse direction. The tows can be interlaced, for example, by braiding or weaving. Some or all of the tows can be made electrically conductive, for example, by coating the tows with a conductive metal. Conductive strands can also be interlaced with the tows. A structural material is disposed between the tows so that the structural material joins the tows to the structural member. For example, a nonconductive resin can be cured to form the structural member and the structural material joining the tows to the structural member. An insulative sheet can also be disposed in the structural member so that the wire is at least partially surrounded by the insulative sheet.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a plan view of a structural member with an integrated wire according to one embodiment of the present invention;

FIG. 2 is a plan view of the wire of FIG. 1, shown before the wire is integrated with the structural member;

FIG. 3 is a plan view of a wire having a plurality of braided tows according to another embodiment of the present invention;

FIG. 4 is an enlarged plan view of the wire of FIG. 3;

FIG. 5 is a plan view of the wire of FIG. 3, shown impregnated with resin;

FIG. 6 is an enlarged section view of the wire of FIG. 3, as seen along line 6-6 of FIG. 5 and magnified approximately 100 times;

FIG. 7 is a perspective view of a helicopter rotor blade with an integrated wire according to one embodiment of the present invention;

FIG. 8 a partial cut-away view of the helicopter blade of FIG. 7; and

FIG. 9 is a flow diagram illustrating operations for forming a structural member with an integrated wire according to one embodiment of the present invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

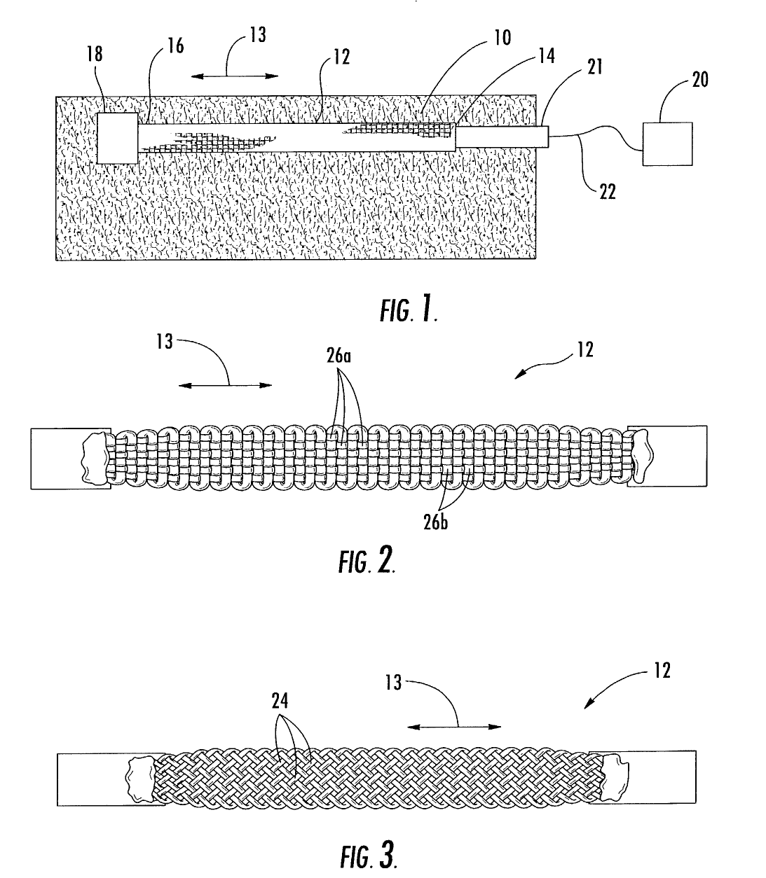

Referring to the drawings and, in particular, FIG. 1, there is shown a structural member 10 according to one embodiment of the present invention that has an integrated wire 12. The structural member 10 can be formed of various materials such as a composite material that includes fibers or tows that are impregnated with a matrix of a cured resin. Alternatively, the structural member 10 can be formed of other conventional materials including polymers, metals, and the like. The term “structural member” is not meant to be limiting, and the structural member 10 can be a single component or an assembly of components, for example, building components or machinery. Further, the structural member 10 can be used in any type of structure including vehicles such as aerospace vehicles, aircraft, ships, land vehicles, and the like.

The wire 12 extends in a generally longitudinal direction 13 along the structural member 10, i.e., the wire 12 extends from a first end 14 to a second end 16 such that the wire 12 can be used to electrically connect two or more electrical devices 18, 20. The term “longitudinal” is intended to indicate generally that the wire 12 extends generally between two or more ends or connections spaced apart in a longitudinal direction, though the particular path of the wire 12 need not be a straight or direct path. Instead, the integrated wire 12 may be routed according to a variety of design factors that are particular to the structural member 10 including, for example, the shape of the structural member 10, the placement of the electrical devices 18, 20, the anticipated variation of stress and strain throughout the structural member 10, and the like. More than two electrical devices 18, 20 can be connected by the wire 12, and the devices 18, 20 can also be connected at different locations along the wire 12.

The wires 12 can be used to connect a variety of electrical devices 18, 20. According to one embodiment of the invention shown in FIG. 1, the first electrical device 18 is a sensor, actuator, or light-emitting device, and the second electrical device 20 is a computer, processor, power supply, or other circuit device that is connected to the wire 12 to receive data from the first electrical device 18, transmit control signals to the first electrical device 18, and/or supply power to the first electrical device 18 via one or more of the wires 12. The integrated wire 12 can also provide an electrical ground path between the devices 18, 20. The electrical devices 18, 20 can be mounted on or in the structural member, and the integrated wire 12 can extend to the electrical devices 18, 20 or the wire 12 can be connected to the devices 18, 20 by another electrical conductor, such as a contact 21 and/or a connection wire 22. The contact 21 and connection wire 22 can be formed of conductive metals or composite structures that include conductive tows or metallic strands. For example, the connection wire 22 can be a conventional conductive wire or a structurally integrated wire according to the present invention. The connection wire 22 can be connected to the wire 12 directly or via the contact 21, which can be formed of metal or a conductive epoxy pad.

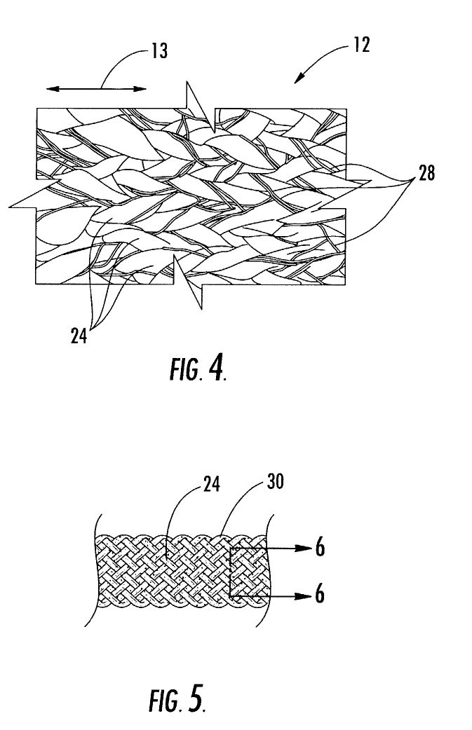

Each wire 12 is formed of a plurality of tows 24 that extend generally in the longitudinal direction 13 of the wire 12. By the term “plurality,” it is meant that more than one portion of the tows 24 extends in the longitudinal direction, although multiple longitudinal tow portions could be formed by folding a single continuous piece of tow 180 degrees so that the plurality of tows 24 is actually formed of as few as one piece of tow. The tows 24 can be interlaced, for example, in a braided or a woven configuration. An exemplary woven configuration is illustrated in FIG. 2, but it is understood that other weave patterns can also be used. For example, weave patterns can include plain weaves, twill-square weaves, Hollander weaves, and the like. The plain weave pattern illustrated in FIG. 2 is characterized by a plurality of warp tows 24a that extend in the longitudinal direction 13 and a plurality of weft tows 24b that extend in a transverse direction. In the plain weave, each warp tow 24a passes above then below each of the consecutive weft tows 24b, and each weft tow 24b passes above then below each consecutive warp tow 24a. Thus, although the tows 24a extend generally longitudinally, each tow 24a follows a nonlinear path that is curved to accommodate the transverse weft tows 24b.

The tows 24 can also be configured in any braid pattern, including twisted braids, round braids, square braids or square plaits, interbraids, and the like. FIG. 3 illustrates an exemplary braid configuration in which each of the plurality of tows 24 is disposed at an angle of about 45 degrees from the longitudinal direction 13 of the wire 12. The tows 24 extend transversely as well as longitudinally and follow curved paths to accommodate the other braided tows 24. Thus, the tows 24 extend generally in the longitudinal direction 13 but are nonlinear.

Regardless of the particular arrangement and interlacing of the tows 24, the tows 24 can be non-linear, or multi-dimensional, so that each tow 24 follows a more circuitous route than the wire 12. In other words, the tows 24 can have a component of extension in a direction transverse to the general longitudinal extension of the wire 12 such that the length of each tow 24 is longer than the corresponding length of the wire 12. For example, each of the warp and weft tows 24a, 24b of the woven wire 12 shown in FIG. 2 generally define an alternately curving shape, or repeated S-shape. Further, each tow 24 can extend in more than one transverse direction so that each tow 24 defines a non-planar shape, i.e., a three-dimensional shape. For example, each of the tows 24 of the braided wire 12 shown in FIG. 2 can define a three-dimensional shape that curves to accommodate the other tows 24 while extending back and forth in the transverse direction by the width of the wire 12.

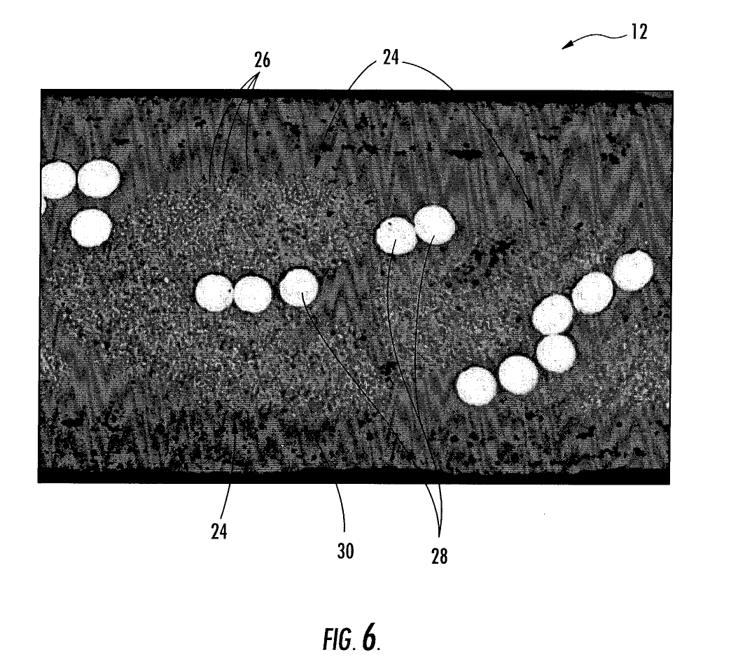

As shown in FIGS. 4 and 6, each tow 24 can be formed of a plurality of fibers 26. In some cases, each tow 24 can include thousands of individual fibers 26 that can be formed of materials including, but not limited to, carbon, nylon, fiberglass, and aramids such as Kevlar® fibers, a registered trademark of E. I. du Pont de Nemours and Company. The use of tows formed of materials such as carbon fibers, sometimes referred to as graphite, for forming composite materials is known in the art. Carbon fibers and other fibers can be formed according to a variety of methods, which are sufficiently known to those skilled in the art that a description herein is unnecessary for a thorough understanding of the present invention.

The wire 12 is electrically conductive such that the wire 12 can be used for transmitting an electrical signal or electrical power along its length. The electrical conductivity of the wire 12 is improved by providing a conductive material in, on, or among the fibers 26 or tows 24. According to one embodiment of the present invention, one or more of the fibers 26 of one or more of the tows 24 are coated with an electrically conductive material including metals such as silver, nickel, gold, copper, beryllium, aluminum, and alloys thereof. For example, a coating of the conductive material, such as nickel or copper, can be disposed on the fibers 26 by electroplating, vapor deposition, or other coating methods, and the fibers 26 can then be spun to form the tows 24. Some or all of the fibers 26 can be coated with the conductive material. Further, the tows 24 can also be coated with the conductive material after the tows 24 have been formed from the fibers 26.

The electrical conductivity of the wire 12 can also be improved by providing strands 28 of a conductive material between the fibers 26 or tows 24. The conductive strands 28 can be formed of a variety of electrically conductive materials including conductive metals such as copper, gold, silver, beryllium, aluminum, and alloys or mixtures thereof. For example, the wire 12 illustrated in FIG. 4 includes strands 28 formed of copper, such as copper alloy CDA 101. The copper strands 28 are braided with the tows 24 of the wire 12, but in other embodiments, the copper strands 28 can be woven with the tows 24. Alternatively, the strands 28 can be spun with the fibers 26 of the tows 24 by intertwining the strands 28 with the fibers 26, spiraling the strands 28 around the fibers 26, or otherwise disposing the strands 28 within the tows 24.

Thus, the wire 12 generally can be formed of any combination of conductive, semiconductive, and nonconductive tows 24, and any number of solid, conductive strands 28, which can be within the tows 24, interlaced with the tows 24, or otherwise disposed within the wire 12. Any of the fibers 26, tows 24, and strands 28 can also be coated.

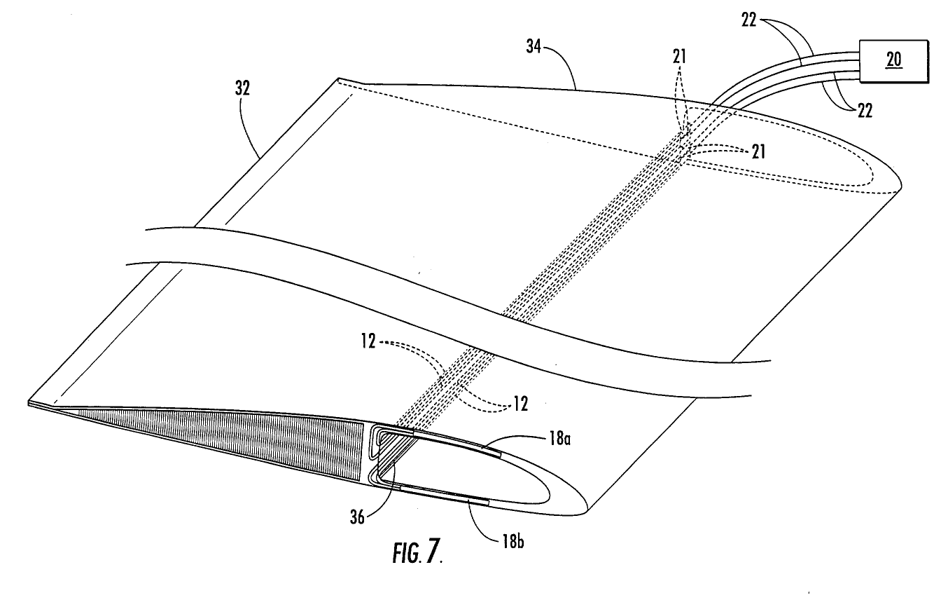

The wires 12 can be integrated with the structural member 10 by configuring the wire 12 on the structural member 10 and disposing a structural material 30 between the tows 24 to join the tows 24 to the structural member 10. By the term “on,” it is meant that the wire 12 is configured on the surface of the structural member 10, within the structural member 10, or partially within the structural member 10. The structural material 30 at least partially fills, and can completely fill, the spaces within and between the tows 24 of the wire 12 as shown in FIGS. 5 and 6. The structural material 30 can be any of a variety of matrix materials for forming composite structures. For example, the structural material 30 can be an epoxy, phenol resin, polyester, cyanate ester, bismaleimide, vinyl ester resin, and the like. Additionally, the structural member 10 can be formed of a composite material, and the structural material 30 can include the same type of material as the matrix or resin of the structural member 10.

The integrated wire 12 can be infused, or impregnated, with the structural material 30 while the composite structural member 10 is being cured, for example, by disposing the wire 12 and the structural material 30 on the structural member 10 after the structural member 10 has been formed but before the matrix material of the structural member 10 has been cured. Thus, the matrix of the structural member 10 and the structural material 30 can be cured at the same time. In some cases, there can be sufficient matrix material in the structural member 10 such that the matrix material of the structural member 10 infuses the wire 12 and no additional structural material 30 need be provided. Alternatively, the structural member 10 can be fully formed before the structural material 30 is cured. The structural member 10 can also be formed of a non-composite material, such as metal, which does not require curing.

The structural material 30 can be applied to the wire 12 before the wire 12 is configured on the structural member 10 or after the wire 12 is configured thereon. In one embodiment of the invention, the wire is vacuum bagged to a surface of the structural member 10, and the wire 12 can be bagged with the structural member 10 to imbed the wire 12 therein. Contacts 21 and/or connection wires 22 can also be embedded, or partially embedded, in the structural member 10 to provide electrical connection to the wire 12. For example, the contacts 21 and connection wires 22 can be positioned in electrical contact with the wire 22 and cured partially within the wire 12 and/or the structural member 10.

After the structural material 30 is disposed, the structural material 30 is cured so that the structural material 30 joins the tows 24 and/or strands 28 of the wire 12 and joins the wire 12 to the structural member 10. Thus, the wire 12 is integrated with the structural member 10 so that the wire 12 is connected to the structural member 10 without requiring fasteners such as clips. The wire 12 can be integrated with any type and configuration of structural member 10, and the tows 24 and strands 28 of the wire 12 can be shielded by the structural member 10 and/or the structural material 30 to protect the wire 12 from ambient conditions such as temperature variations, moisture, corrosives, and the like. Additional layers of electrical shielding can also be provided over, under, or around the wire 12.

The conductive tows 24 and the strands 28 can contact one another so that each is electrically connected in a transverse direction and electrical current flowing longitudinally through the wire 12 can also flow in a transverse direction. For example, if one of the conductive tows 24, fibers 26, or strands 28 breaks, current can flow transversely from the broken tow 24, fiber 26, or strand 28 and around the broken portion through the other conductive tows 24, fibers 26, or strands 28. Thus, the wire 12 provides alternative paths for the current in the event that any of the individual tows 24, fibers 26, or strands 28 is broken, worn, or otherwise rendered nonconductive. In addition, the tows 24 and strands 28 of the wire 12 are configured in a non-linear configuration so that at least some portions of the tows 24 and strands 28 are not parallel with the longitudinal direction 13. Therefore, when the structural member 10 and the wire 12 is strained in the longitudinal direction 13, at least a portion of the tows 24 and strands 28 are subjected to a lower strain.

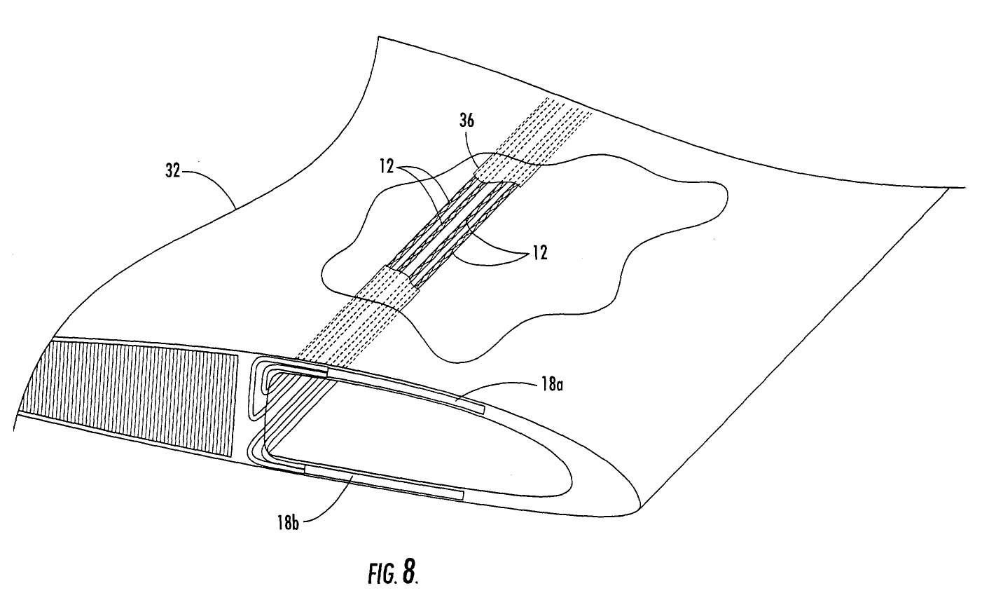

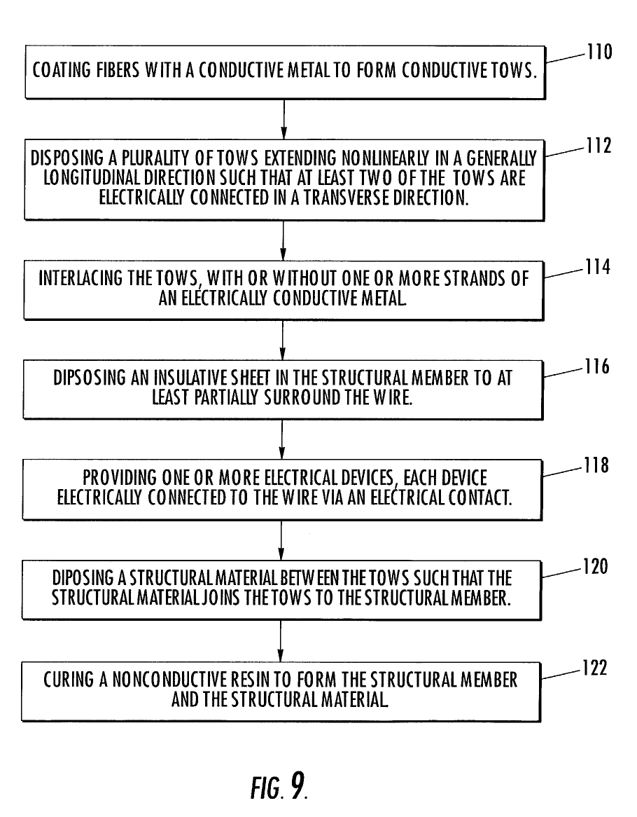

Each structural member 10 can include multiple independent wires 12. For example, FIGS. 7 and 8 illustrate a helicopter rotor blade 32 with four integrated wires 12. The wires 12 are configured to extend longitudinally from a first end 34 of the blade 32 to two electrical devices 18a, 18b mounted in the blade. The electrical devices 18a, 18b are piezo-fiber actuator packs, which can provide active aerodynamic control and vibration reduction. In other embodiments, however, each of the electrical devices 18a, 18b can also or alternatively include other devices, for example, a sensor, such a strain gauge, which senses deformation in the rotor blade 32. Conventional wires 22 connect the wires 12 via contacts 21 to a circuit device 20 mounted in the helicopter that monitors, actuates, and powers the device 18. Although the wires 12 are used to separately connect two electrical devices 18a, 18b in FIG. 7, the wire 12 can include multiple joined segments or branches and can be used to connect any number of electrical devices 18a, 18b. Additionally, as shown in FIG. 8, an insulative sheet 36 can be disposed under, over, around, or partially around the wires 12 so that each wire 12 is electrically isolated from other wires, physical intrusion, and the like. The sheet 36 can be provided in a laminar configuration that disposed against the wires 12 or wrapped around the wires 12, a tube in which one or more of the wires 12 are inserted, or material otherwise disposed in the structural member 10 to provide a protective barrier for the wires 12. The sheet 36 can be formed of a variety of materials including fiberglass, non-conductive resins, polyimide sheets, or other non-conductive materials. The sheet 36 can also be treated, for example, by plasma etching, to improve the adhesion of the sheet 36 to the structural member 10. Further, a conductive material can be provided as a grounding sheet around the wires 12, for example, by disposing the conductive material between two of the insulative sheets 36.

There is shown in FIG. 9 a flow chart illustrating a number of operations for manufacturing a wire integrated with a structural member according to one embodiment of the present invention. Some of the illustrated operations can be omitted and other operations can be included according to other embodiments of the invention. The wire is formed of a plurality of tows, some or all of which can be electrically conductive. The tows can be made conductive by coating a conductive metal on the tows. For example, fibers formed of carbon, nylon, aramids, or fiberglass can be coated with metals such as silver, nickel, gold, copper, beryllium, aluminum, and alloys thereof. See block 110. The tows are disposed along the structural member to extend nonlinearly in a generally longitudinal direction such that at least two of the tows are electrically connected in a transverse direction. See block 112. The tows can be interlaced, for example, by braiding or weaving, and one or more strands formed of an electrically conductive metal can be interlaced with the tows. See block 114. An insulative sheet can be disposed in the structural member to at least partially surround the wire. See block 116. One or more electrical devices can be electrically connected to the wire, for example, via electrical contacts. See block 118. A structural material is disposed between the tows and is cured such that the structural material joins the tows to the structural member. See block 120. For example, a nonconductive resin can be cured to form the structural member and the structural material. See block 122.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A wire adapted to be integrated with a structural member, the wire comprising:
a plurality of nonlinear tows extending generally in a longitudinal direction, each said tow including a plurality of fibers, said plurality of tows including at least two conductive tows including an electrically conductive metal, said conductive tows being electrically connected in a transverse direction generally perpendicular to the longitudinal direction of the tows; and
a structural material disposed between said plurality of tows and capable of joining said plurality of tows to the structural member.

2. A wire according to claim 1 wherein said plurality of tows is arranged in an interlaced configuration.

3. A wire according to claim 2 wherein said plurality of tows is arranged in a braided configuration.

4. A wire according to claim 2 wherein said plurality of tows is arranged in a woven configuration.

5. A wire according to claim 1 wherein each conductive tow includes a plurality of nonmetallic fibers, at least one of said fibers being coated with an electrically conductive metal.

6. A wire according to claim 5 wherein each conductive tow comprises at least one fiber formed of at least one of the group consisting of carbon, nylon, aramids, and fiberglass coated with at least one of the group consisting of silver, nickel, gold, copper, beryllium, aluminum, and alloys thereof.

7. A wire according to claim 1 further comprising at least one conductive strand interlaced with the tows, each conductive strand comprised of an electrically conductive metal.

8. A wire according to claim 7 wherein each conductive strand is formed of at least one of the group consisting of silver, nickel, gold, copper, beryllium, aluminum, and alloys thereof.

9. A wire according to claim 1 wherein the structural material is formed of a cured, electrically nonconductive resin.

10. A wire according to claim 1 further comprising an insulative sheet at least partially surrounding the wire.

11. A wire according to claim 1 further comprising at least one metallic contact in electrical communication with the wire, said contact being at least partially embedded in the structural member.

12. A wire adapted to be integrated with a structural member, the wire comprising:
at least one nonlinear tow extending generally in a longitudinal direction, each tow including a plurality of nonmetallic fibers;
at least two conductive strands interlaced with the tows, each conductive strand comprised of an electrically conductive metal, said conductive strands being electrically connected in a transverse direction generally perpendicular to the longitudinal direction of the at least one tow; and
a structural material disposed between said tows and strands and capable of joining said tows and strands to the structural member.

13. A wire according to claim 12 wherein said tows and strands are arranged in a braided configuration.

14. A wire according to claim 12 wherein said tows and strands are arranged in a woven configuration.

15. A wire according to claim 12 wherein at least one of the fibers of the tows is coated with an electrically conductive metal.

16. A wire according to claim 12 wherein each tow comprises at least one fiber formed of at least one of the group consisting of carbon, nylon, aramids, and fiberglass coated with at least one of the group consisting of silver, nickel, gold, copper, beryllium, aluminum, and alloys thereof.

17. A wire according to claim 12 wherein each conductive strand is formed of at least one of the group consisting of silver, nickel, gold, copper, beryllium, aluminum, and alloys thereof.

18. A wire according to claim 12 wherein the structural material is formed of a cured, electrically nonconductive resin.

19. A wire according to claim 12 further comprising an insulative sheet at least partially surrounding the wire.

20. A wire according to claim 12 further comprising at least one metallic contact in electrical communication with the wire, said contact being at least partially embedded in the structural member.

21. A structural member having at least one integrated wire, the structural member comprising:
a composite structure;
at least one integrated wire disposed on said composite structure, each wire having a plurality of nonlinear tows extending generally in a longitudinal direction, each tow including a plurality of fibers;
a structural material disposed between said plurality of tows and joining said plurality of tows to the structural member;
a first electrical device connected to a first end of the wire; and
a second electrical device connected to a second end of the wire, said wire electrically connecting said first and second electrical devices.

22. A structural member according to claim 21 wherein said composite structure at least partially comprises a blade of a helicopter rotor, said blade having a first end connected to a hub and a second end extending therefrom, said at least one wire extending generally in a direction between said first and second ends of said blade.

23. A structural member according to claim 21 wherein at least one of said first and second electrical devices comprises at least one of the group consisting of a sensor, actuator, and light-emitting device.

24. A structural member according to claim 21 wherein said plurality of tows is arranged in an interlaced configuration.

25. A structural member according to claim 24 wherein said plurality of tows is arranged in a braided configuration.

26. A structural member according to claim 24 wherein said plurality of tows is arranged in a woven configuration.

27. A structural member according to claim 21 wherein at least one of said tows includes a plurality of nonmetallic fibers coated with an electrically conductive metal.

28. A structural member according to claim 27 at least one of said tows comprises at least one fiber formed of at least one of the group consisting of carbon, nylon, aramids, and fiberglass coated with at least one of the group consisting of silver, nickel, gold, copper, beryllium, aluminum, and alloys thereof.

29. A structural member according to claim 21 wherein each wire comprises at least one conductive strand interlaced with the tows, each conductive strand comprised of an electrically conductive metal.

30. A structural member according to claim 29 wherein each conductive strand is formed of at least one of the group consisting of silver, nickel, gold, copper, beryllium, aluminum, and alloys thereof.

31. A structural member according to claim 21 further comprising at least one insulative sheet disposed in the structural member, each said sheet at least partially surrounding at least one of said wires.

32. A method of manufacturing a wire integrated with a structural member, the method comprising:
disposing a plurality of electrically conductive tows extending nonlinearly in a generally longitudinal direction between electrical devices such that the electrical devices are capable of being electrically connected by the wire and at least two of the tows are electrically connected in a transverse direction; and
disposing a structural material between the tows such that the structural material joins the tows to the structural member.

33. A method according to claim 32 further comprising interlacing the tows.

34. A method according to claim 33 wherein said interlacing step comprises braiding the tows.

35. A method according to claim 33 wherein said interlacing step comprises weaving the tows.

36. A method according to claim 33 wherein said interlacing step comprises interlacing at least one electrically conductive tow with at least one electrically nonconductive tow.

37. A method according to claim 32 further comprising coating a plurality of fibers with an electrically conductive metal to form the conductive tows.

38. A method according to claim 37 wherein said coating step comprises coating fibers formed of at least one of the group consisting of carbon, nylon, aramids, and fiberglass with at least one of the group consisting of silver, nickel, gold, copper, beryllium, aluminum, and alloys thereof.

39. A method according to claim 32 further comprising interlacing at least one strand formed of an electrically conductive metal with the tows.

40. A method according to claim 32 further comprising curing a nonconductive resin to form the structural member and the structural material.

41. A method according to claim 32 further comprising disposing an insulative sheet in the structural member such that the wire is at least partially surrounded by the insulative sheet.

42. A method according to claim 32 further comprising providing one or more electrical contacts, each contact electrically connecting at least one of the electrical devices to the wire.
